(19) United States
(12) Patent Application Publication
(10) Pub. No.: US 2008/0067798 A1
(43) Pub. Date: Mar. 20, 2008

(54) Bookbinding and art framing zip tie system

(76) Inventor: Daryl Lee Tempesta, Scotts Valley, CA (US)

Correspondence Address: STEVEN A. NIELSEN;ALLMAN & NIELSEN, P.C, 100 Larkspur Landing Circle, Suite 212, LARKSPUR, CA, 94939, US

(21) Appl. No.: 11/533,230

(22) Filed: Sep. 19, 2006

(51) Int. Cl. B42D 1/00

(52) U.S. Cl. 281/21.1

(57) ABSTRACT

Bookbinding and the framing of artwork and documents are achieved by use of flexible zip ties. Tamper-resistant and tamper-evident bindings are created by the use of hinges, frames and/or plates that are secured to paper or artwork with zip ties or integrated zip tie components. The disclosed invention allows consumers to self-authenticate and self-secure documents and artwork. In variations of the disclosed invention, the components of a zip tie are seamlessly integrated into bookbinding and art framing mechanisms to achieve simplicity of use and eloquence of design. RFID and memory chips may be attached to the zip ties to achieve new levels of document security and efficient tracking of documents.

### CROSS-REFERENCE TO RELATED APPLICATIONS

This application claims the benefit and filing date of provisional application No. 60/595,388 entitled “Bookbinding and art framing zip tie system” filed on Sep. 20, 2005.

### STATEMENT REGARDING FEDERALLY SPONSORED RESEARCH OR DEVELOPMENT

Not Applicable.

### REFERENCE TO A SEQUENCE LISTING

Not Applicable.

### BACKGROUND OF THE INVENTION

(1) Field of the Invention

This invention relates to bookbinding and the framing of paper and artwork.

### (2) Description of the Related Art

The related art fails to provide quick and economical means to bind books or frame artwork as disclosed in the present invention. For example, U.S. patent application 2004/0131446 by Acquaviva discloses a binding system comprising a stud with top and bottom caps. Acquaviva fails to disclose means of providing quick adjustment to the length of the binding material. Acquaviva also fails to disclose means of embedding an electronic tracking device.

Thus, there is a need in the art for means and methods of binding paper and other materials in an efficient, secure, quick, and economic manner.

### BRIEF SUMMARY OF THE INVENTION

The present invention overcomes shortfalls in the related art by disclosing means and methods of bookbinding and framing paper and artwork by use of novel framing and binding techniques utilizing flexible zip ties. Consumers are able to use the disclosed invention to economically bind books and frame artwork by means that are tamper-resistant and tamper-evident. In variations of the disclosed invention, zip tie parts are built into the disclosed bookbinding and framing components.

Security is achieved by use of locking mechanisms that may be attached to the binding components or may be part of a traditional zip tie. For permanent bookbinding or art framing the locking mechanisms allow one-way movement of a tail or a flexible strip. In such an application, the locking mechanism, tail or flexible strip will break when more than normal pressure is applied. When broken, the locking mechanism, tail or flexible strip become useless and are un-repairable. In an alternative embodiment of the present invention, pigmenting material is released upon breakage of a securing component.

For non-permanent applications, the locking mechanisms or heads may be adjusted to allow two-way movement of a tail or a flexible strip. These locking mechanisms allow temporary and/or reusable bindings. Such an adjustable locking mechanism may be created by use of a paperclip to push open a locking tooth. Or, a release tab may be attached to the locking tooth. Extra reliability may be achieved by using a double sided locking tooth design.

In either permanent or reusable applications, the tails or flexible strips may be relatively flat, or take on alternative shapes to complement the bookbinding or art framing components. All variations of the disclosed invention include the use of permanent or reusable locking mechanisms. All variations of the disclosed invention contemplate the snug securing of paper and the construction of loose leaf binders.

For applications using removable hinges, tab lock hinges, or similar variations of the disclosed invention, the use of pre-applied adhesives, glue, glue point, Velcro, stickers with peel-off surfaces is contemplated. Such means of attachment are defined herein as “glue-Velcro attachments” and may be used in conjunction with the flexible strips and locking mechanisms. Glue-Velcro attachments may be used as temporary bindings and may later be part of more permanent bindings by use with flexible strips and locking mechanisms.

Additional security and the ability to track, inventory and manage documents is provided by means of insertion of Radio Frequency Identification (“RFID’) chips. Classified, top-secret, and/or proprietary material may be tracked in real time. Means of identification may also include the use of other technology embedded into the disclosed zip tie systems. Identification may occur by any means, including illumination and/or sound.

The disclosed invention also provides “Document Awareness” wherein RFID and/or memory chips imbedded into the binding apparatus. The embedded RFID and/or memory chips may hold the contents of the document and facilitate instant printing and/or instant duplication.

### BRIEF DESCRIPTION OF THE DRAWINGS

FIG. 1 shows a hinge system of bookbinding utilizing the principles of the present invention.

FIG. 2 shows a plate system of book binding utilizing the principles of the present invention.

FIG. 3 shows the application of multi/decorative plates used in accordance with the present invention.

FIG. 4 shows bookbinding means and methods using a full cover and enclosure mechanism in accordance with the present invention.

FIG. 5 shows a side tab application in accordance with the present invention.

FIG. 6 shows a back view of a side tab application in accordance with the present invention.

FIG. 7 shows several details of a tab method of fastening in accordance with the present invention.

FIG. 8 shows binder variations of bookbinding and artwork framing in accordance with the present invention.

FIG. 9 shows tunnel variations of bookbinding and artwork framing in accordance with the present invention.

FIG. 10 shows means and methods of encased document binding in accordance with the present invention.

FIG. 11 shows a modular system to frame and/or encase three dimensional objects.

FIG. 12 shows opening and locking mechanism variations.

FIG. 13 shows various means of tracking and identification.

### DETAILED DESCRIPTION OF THE INVENTION

Although the following detailed description contains many specific details for the purposes of illustration, anyone of ordinary skill in the art will appreciate that many variations and alterations to the following details are within the scope of the invention. Accordingly, the exemplary embodiments of the invention described below are set forth without any loss of generality to, and without imposing limitations upon, the claimed invention.

Definition List 1

| Term | Definition |
|---|---|
| zip tie | A flexible fastener known in the art as a |
| | “zip tie” or ‘nylon pull tie”. A “zip tie” |
| | fastener may be made of nylon or any |
| | strong flexible material. A “zip tie” is a |
| | one piece fastener comprising a self- |
| | locking head that accepts a tail. The |
| | fastener tail section or “tail” has |
| | serrations or beads on one or many |
| | sides that permit an easy pull through a |
| | head or locking mechanism. Once the |
| | tail is fastened through the head the tail |
| | self-locks. The tail may also be secured |
| | by any locking mechanism. Locking |
| | mechanisms may be located in binding |
| | or framing components. The tail need |
| | not be cut, and may be secured and/or |
| | concealed within a binding or framing |
| | component. |
| head | Is the self-locking mechanism found at |
| | the end of the zip tie tail. The “head” |
| | accepts and secures the tail. The head |
| | mechanism may have means to secure a |
| | tail in a temporary fashion, or in a |
| | permanent manner to create a tamper- |
| | evident and tamper-resistant binding. |
| tail | Is the portion of a zip tie that may attach |
| | through a head or separate locking |
| | mechanism. The “tail” is used to secure |
| | objects and passes through a head |
| | mechanism or other locking mechanism |
| | to achieve a permanent or temporary |
| | attachment. The “tail” may be multi- |
| | sided with groves or beads on multi- |
| | sides. A “tail” or similar component with |
| | one side attached to a binding or |
| | framing component may be called a |
| | “flexible strip.” |
| locking mechanism | May be found in a head or in a binding |
| | or framing component. A “locking |
| | mechanism” may have means to secure a |
| | tail or flexible strip in a temporary |
| | fashion or in a permanent manner. |

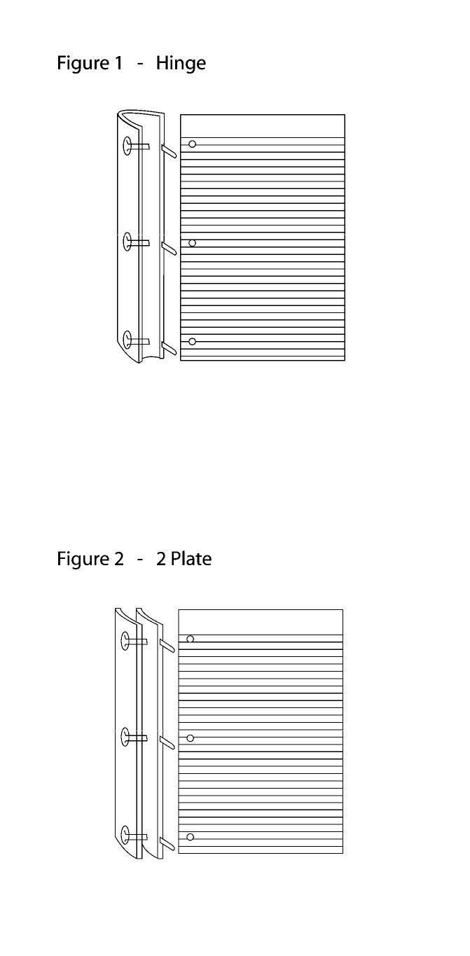

Referring to the drawings, FIG. 1 shows a hinge variation of the disclosed invention. The hinge is made of flexible or rigid material having means to accept paper and a zip tie or plurality of zip ties to allow the binding of paper into the hinge. The disclosed hinge variation also contemplates the use of integrated flexible strips and integrated locking mechanisms.

After passing through the hinge, paper and head, the tail may be cut or may be left in tact. When using one-way locking mechanisms, this fastening method results in a tamper-resistant and tamper-evident bookbinding. The binder may be held together by pressure on the binding spine or hinge. This pressure is created by tails or flexible strips and locking mechanisms.

FIG. 2 shows a variation of the hinge system of FIG. 1 by use of 2 individual plates that are fastened to each other and the paper by use of zip ties or flexible strips. The plate method shown in FIG. 2 is suitable for bookbinding a relatively small or relatively large amount of book pages.

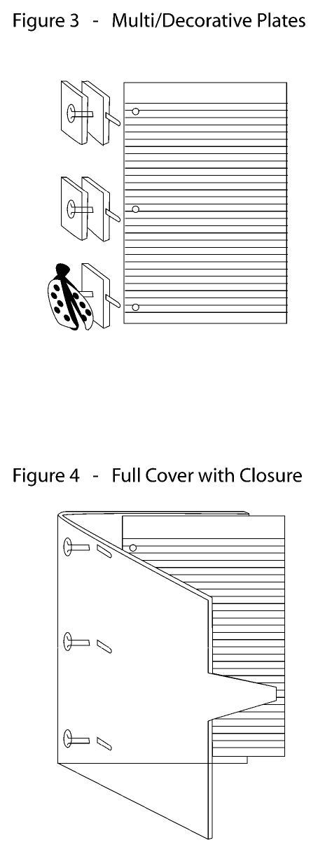

FIG. 3 is a variation of the plate system of FIG. 2. In FIG. 3 six plates are used in a bookbinding method that is also suitable to accept decorative additions. The method of FIG. 3 may use two or more plates. The plate method of FIG. 3 allows users to carry small and portable book binding kits that may be deployed where needed.

FIG. 4 describes a full cover system and closure system in accordance with the disclosed invention. The cover of FIG. 4 may be flexible or rigid.

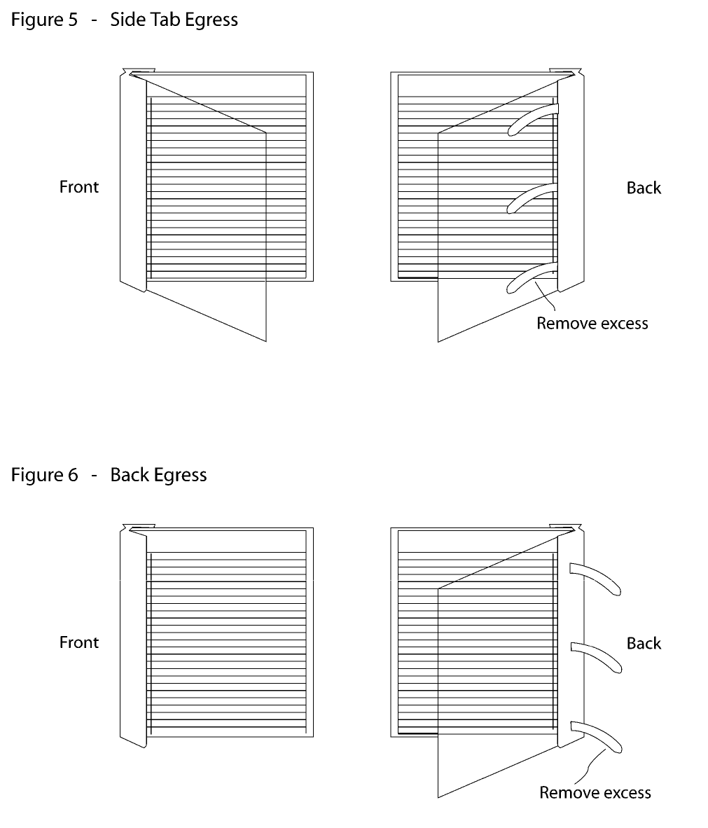

FIG. 5 illustrates a bookbinding system not using the traditional zip tie. Instead, one end of a flexible strip, similar to a tail, is permanently attached to a front binding piece. The opposite end of the flexible strip passed through the paper and through a backend binding piece. The backend binding piece has a locking mechanism. The flexible strip that remains to the outside of the backend piece may be cut or left in tact.

FIG. 6 is a back view of the integrated binding system shown in FIG. 5 and demonstrates a flexible strip passing through an integrated locking mechanism. The locking mechanism is contained within the backend binding piece.

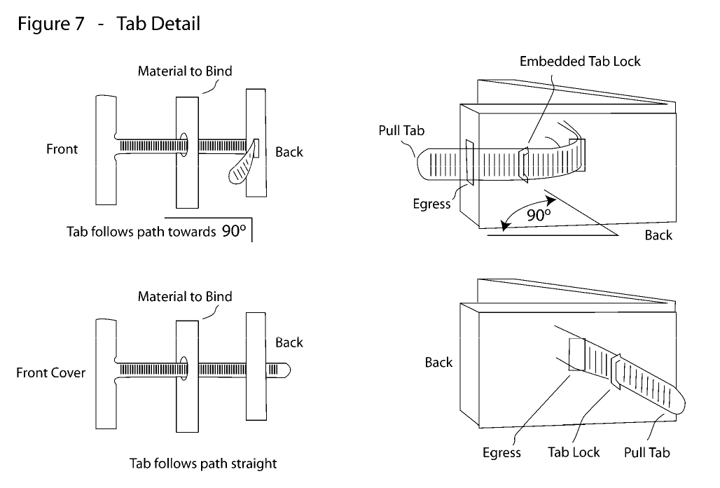

FIG. 7 is a detailed view of the integrated bookbinding system of FIGS. 5 and 6. FIG. 7 shows means and methods of integrating the functions and components of a zip tie into a front and back binding system where separate zip ties are not needed. Functionality and simplicity are obtained by permanently attaching one end of a flexible strip to the front binder component and giving the back binder component means to secure the flexible strip. The back binder component has an integrated locking mechanism that accepts the flexible strip.

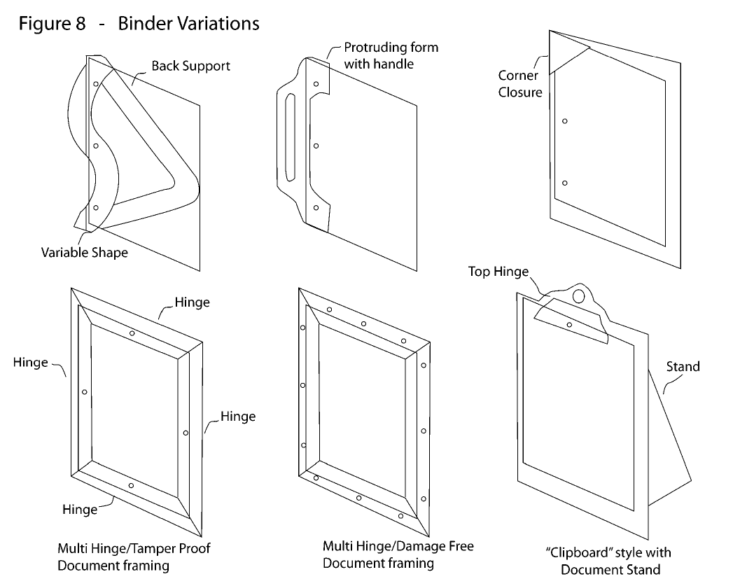

FIG. 8 shows a number of bookbinding and art framing variations in accordance with the disclosed invention. Damage free document binding or framing are shown, as well as various binder designs.

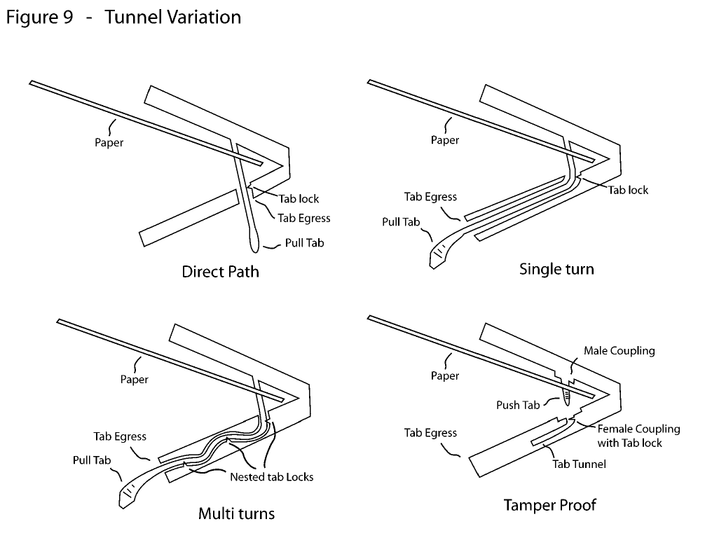

FIG. 9 shows a tunnel system where a flexible strip end is permanently attached to the front side of the binding component. After passing through the paper, the flexible strip reenters the binding component at the rear side by means to hide the flexible strip. The rear side of the binding component has means to accept the flexible strip by use of an integrated locking mechanism. The unused portion of the flexible strip may be hidden in the tunnel portion, negating the need to cut the flexible strip. The tunnel feature creates a tamper-resistant and tamper-evident binding without the need to cut the flexible strip.

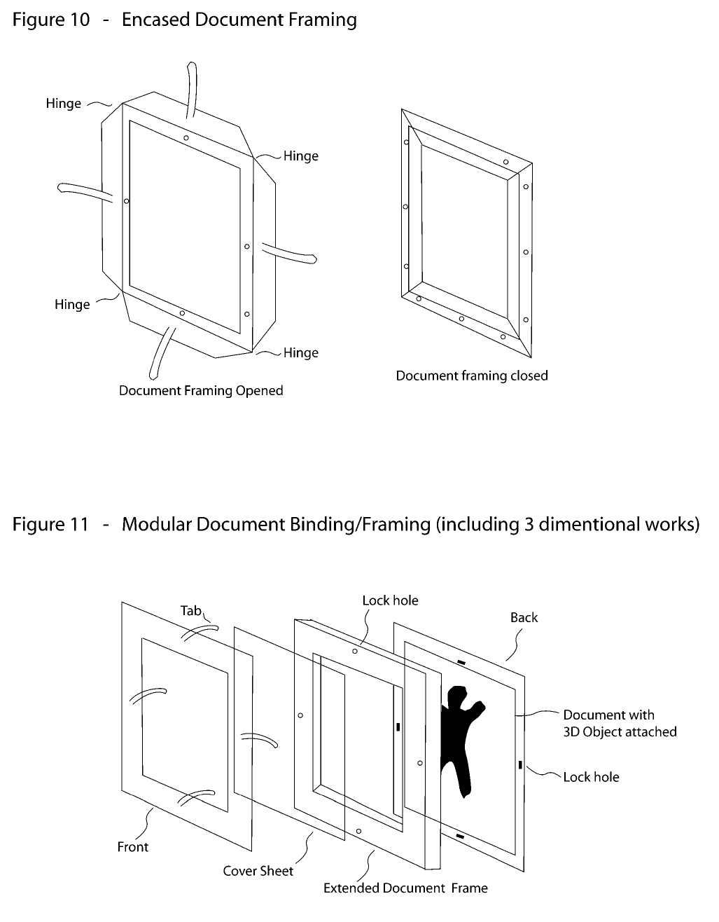

FIG. 10 shows means and methods of encasing documents by use of integrated flexible strips that are permanently attached to the outer portion of the framing member. The opposite ends of the flexible strips pass though an inner section of the framing member. The inner section of the framing member has an integrated locking mechanism.

FIG. 11 illustrates a modular method of framing or encasing three dimensional objects in accordance with the disclosed invention. A front framing member or cover sheet has a plurality of permanently attached flexible strips. The unattached ends of the flexible strips pass through a middle framing member or extended document frame that may be constructed with varying depth to accept objects of varying depth. After passing though the extended document frame, the flexible strips pass though a back member or back cover. The back cover contains integrated locking mechanisms.

The middle framing member may have integrated locking mechanisms that both secure the flexible strips and allow the ends of the flexible strips to pass through the back cover. The additional locking mechanisms in the middle framing member add strength and security to the finished product.

The use of integrated locking mechanisms and flexible strips may also facilitate the fast securing of shipping boxes that are traditionally secured with adhesive tape or adhesive flaps. Foldable shipping boxes, such as traditional cardboard boxes, may be quickly secured by the methods and means of the disclosed invention.

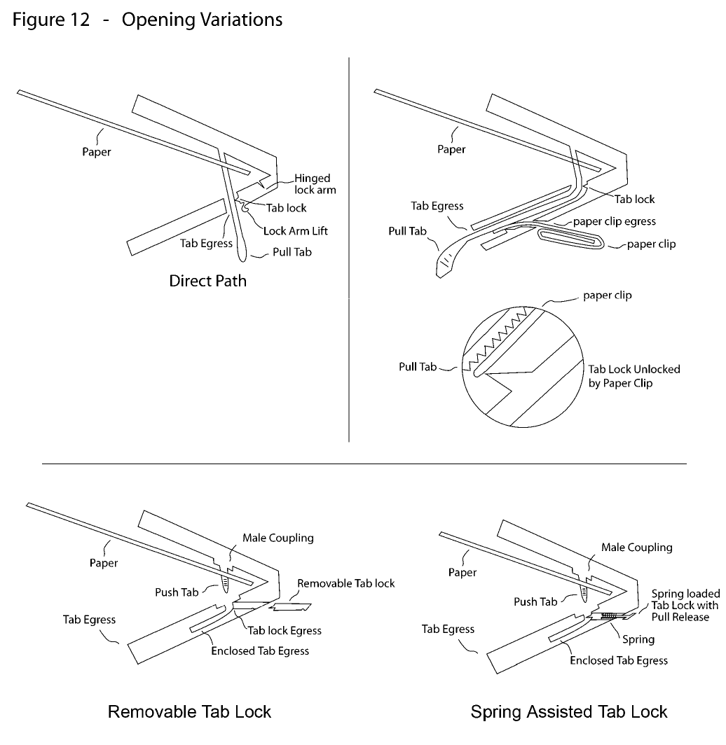

FIG. 12 shows variations to the locking mechanisms and means of securing flexible strips in a hidden manner. The flexible strips of FIG. 12 are concealed within the framing components and do not need to be cut after insertion through the integrated locking mechanisms. The tunnel system of FIG. 12 adds ease of use to a consumer who no longer needs to cut flexible strips to achieve secure bindings. The use of spring assisted locks increases ease of use and simplicity.

The variations of FIG. 12 are well suited for glue-Velcro attachments. The removable lock feature shown in FIG. 12 is well suited for the use of Velcro components as well as glue-Velcro attachments.

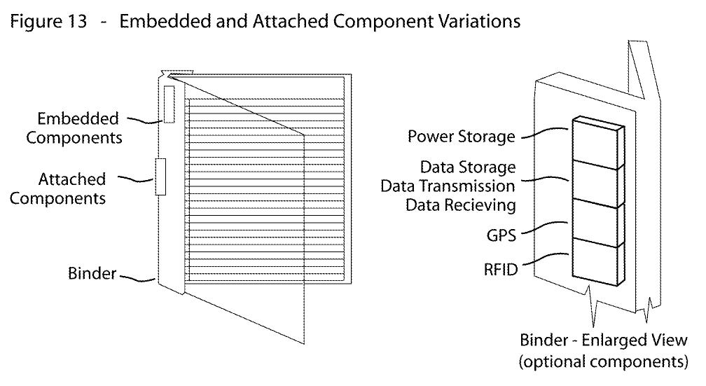

FIG. 13 demonstrates means of embedding power, data storage, data transmission, data receiving, GPS, and RFID into binding components. The embedded and attached components variations may be incorporated into the zip ties or the binder materials.

What is claimed is:

1. A method of bookbinding comprising the insertion of zip ties into pre-punched pages of a book and then inserting the head of the zip tie into the tail of the zip tie, and then pulling the tail of the zip tie to obtain a secure attachment of the pre-punched pages.

2. The method of claim 1 wherein zip ties are integrated into a hinge which holds the pre-punched pages.

3. The method of claim 1 wherein zip ties are inserted through plates that which are fastened on either side of the pre-punched pages.

4. The method of claim 1 used for framing art, wherein zip ties are inserted through pre-punched holes in art frames and pre-punched holes in backing material used to secure material next to the art frame.

5. The method of claim 4 wherein zip tie tails are integrated into art frames.

6. The method of claim 5 wherein zip tie heads are integrated into art frames.

7. The method of claim 1 used for self-authenticating documents where the presence of compromised zip ties renders the pages un-authenticated.

8. The method of claim 4 used for self-authenticating framed material where the presence of compromised zip ties renders the framed material un-authenticated.

9. The method of claim 1 wherein means of identification are embedded into the zip ties.

10. The method of claim 1 wherein one or more memory chips are attached to the zip ties.

11. The method of claim 10 wherein the contents of the pages is recorded on the attached memory chips.

12. A system of securing pre-punched documents comprising:
one or more flexible zip ties; and
pre-punched documents.

13. The system of claim 12 wherein the zip ties are inserted into the openings of the pre-punched documents and the tail of the zip tie is inserted into the head of the zip tie.

14. The system of claim 13 wherein the tail of the zip tie is pulled through the head of the zip tie to secure the pre-punched documents.

15. The system of claim 12 including a hinge that accepts the zip ties and documents.

16. The system of claim 12 including RFIDs secured to the zip ties.

17. The system of claim 12 including memory chips secured to the zip ties.

18. The system of claim 16 including means of tracking the location of the secured documents.

19. The system of claim 17 wherein the memory chips store the contents of the secured documents.

20. A system for securing objects into art frames comprising zip ties integrated into art frames.
